(19) United States
(12) Patent Application Publication
(10) Pub. No.: US 2007/0046168 A1
(43) Pub. Date: Mar. 1, 2007

(54) Current-conducting system for a lamp

(76) Inventors: Jurgen Becker, Berlin (DE); Ursus Kruger, Berlin (DE); Uwe Pyritz, Berlin (DE); Heike Schiewe, Berlin (DE)

Correspondence Address: OSRAM SYLVANIA INC, 100 ENDICOTT STREET, DANVERS, MA, 01923, US

(21) Appl. No.: 11/507,466

(22) Filed: Aug. 22, 2006

(30) Foreign Application Priority Data
Aug. 25, 2005 (DE) 10 2005 040 383.2

(51) Int. Cl. H01J 5/00

(52) U.S. Cl. 313/317

(57) ABSTRACT

Disclosed is a current-conducting system for a lamp with molybdenum foils, gas-tighly embedded in at least one end section of the lamp, at which at two opposite narrow ends in each case an outer current supply conductor and an electrode or an outer current supply conductor and an inner current supply conductor are arranged. According to the invention, the molybdenum foils, current supply conductors and/or electrodes are provided with a coating, at least in sections, that is formed in such a way that the adhesion properties to the glass are improved in the area of the coating, with the coating being applied to the current-conducting system by vacuum-arc ion implantation (Arc-PVD).

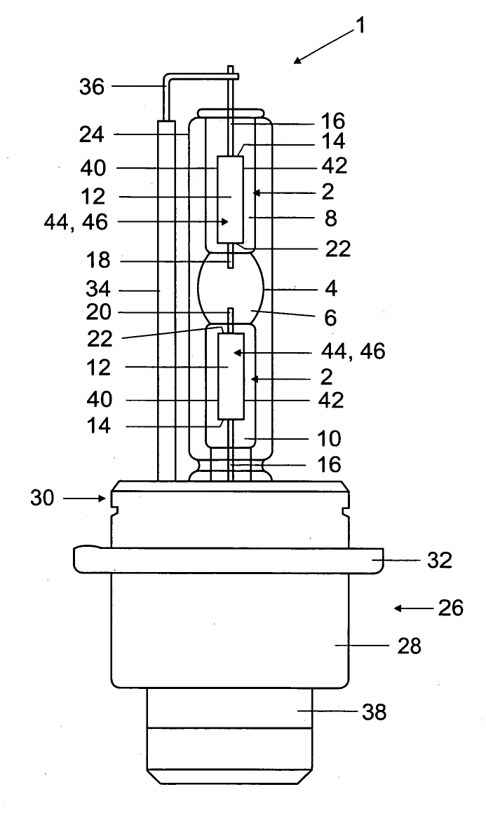

### TECHNICAL FIELD

The invention relates to a current-conducting system for a lamp with molybdenum foils, gas-tightly embedded in at least one end section of the lamp, at which at two opposite narrow ends in each case an outer current supply conductor and an electrode or an outer current supply conductor and an inner current supply conductor are arranged, a method for manufacturing such a current-conducting system and a lamp provided with that type of current-conducting system.

### BACKGROUND ART

Such current-conducting systems are, for example, used for electrical current supplies for discharge lamps, tungsten-halogen lamps and similar with pinched seals of silica glass or hard glass.

Because the glass of the pinch seal has a substantially lower thermal coefficient of expansion than the current supply conductors used to supply an illuminant or electrode system within the lamp vessel with electrical energy, thin molybdenum foils with adequate ductility are frequently used, that despite the different thermal coefficients of expansion of glass and molybdenum enable a gas-tight electrical current supply to be achieved. With solutions of this kind, known for example from DE 197 09 928 A1, both opposite ends of the molybdenum foils are welded to an inner and an outer current supply wire of molybdenum respectively or to an outer current supply wire and an electrode, and the resulting current-conducting system is positioned in the end of the lamp vessel in such a way that the inner current supply conductors or electrodes project into the interior of the lamp vessel and the outer current supply conductors project out from same. The glass at the end of the lamp vessel is then heated and pinched, for example using pinching jaws, to the current-conducting system to form a gas-tight pinch seal. The molybdenum foils are used both to produce the electrically conducting connection between the illuminant or electrode arranged within the lamp vessel and the outer current supply conductors, and to guarantee a gas-tight closure of the lamp vessel.

The disadvantage of current-conducting systems of this kind is firstly that the impurities of the coating due to the sandblasting medium can lead to a leak at the contact point between the lamp glass and molybdenum foil, current supply conductors or electrodes and thus to premature failure of the lamp and a further disadvantage is that the adhesion of the oxide particles to the current-conducting system after sandblasting is low and the molybdenum foils must be subjected to an expensive heat treatment process and are thus expensive to manufacture.

### DISCLOSURE OF THE INVENTION

The object of the invention is to provide a current-conducting system for a lamp, a method for manufacturing a current-conducting system and a lamp fitted with such a current-conducting system, with a tightly-sealed glass-metal transition, compared with conventional solutions being enabled in the area of the embedding of the current conductors at minimum technical expense for the device.

This object is achieved with respect to the current-conducting system by a current-conducting system for a lamp with molybdenum foils, gas-tightly embedded in at least one end section of the lamp, at which at two opposite narrow ends in each case an outer current supply conductor and an electrode or an outer current supply conductor and an inner current supply conductor are arranged, wherein said molybdenum foils, current supply conductors and/or electrodes are provided with a coating, at least in sections, that is formed in such a way that the adhesion properties to the glass are improved in the area of the coating, with the coating being applied to the current-conducting system by means of vacuum-arc ion implantation (Arc-PVD), and with respect to the method by a method for manufacturing a current-conducting system for a lamp with molybdenum foils, gas-tightly embedded in at least one end section of the lamp, at which at two opposite narrow ends in each case an outer current supply conductor and an electrode or an outer current supply conductor and an inner current supply conductor are arranged, with a coating being applied by means of vacuum-arc ion implantation (Arc-PVD) to the molybdenum foils, current supply conductors and/or electrodes, at least in sections, the coating being formed in such a way that the adhesion properties to the glass are improved in the area of the coating. Particularly advantageous embodiments of the invention are described in the dependent claims.

The inventive current-conducting system for a lamp has molybdenum foils gas-tightly embedded in at least one end section of the lamp, at which at two opposite narrow ends in each case an outer current supply conductor and an electrode or an outer current supply conductor and an inner current supply conductor are arranged. According to the invention, the molybdenum foils, current supply conductors and/or electrodes, are provided with a coating, at least in sections, that is formed in such a way that the adhesion properties to the glass are improved in the area of the coating, with the coating being applied to the current-conducting system by means of vacuum-arc ion implantation (Arc-PVD). The coating substantially improves the adhesion between the current-conducting system and the lamp glass. By applying the coating using the vacuum-arc ion implantation method, a large part of the vaporized coating material is accelerated in the direction of the substrate (current-conducting system) and implanted in same or deposited on the surface of the substrate. The ions of the coating material thus penetrate into the uppermost layers of atoms of the substrate due to their high kinetic energy and thus form a coating closely enmeshed with the substrate that has high adhesive strength. In this case, it is advantageous if the vacuum coating process runs continuously, i.e. no intermediate ventilation of the vacuum chamber takes place and thus no impurities of the coating occur, that could lead to a leak in the contact point between the lamp glass and molybdenum foils, current supply conductors or electrodes and thus to premature failure of the lamp. Furthermore, because of the high quality of the adhesion of the coating to the current-conducting system, there is no need for an expensive heat treatment process.

With the method according to the invention for manufacturing a current-conducting system for a lamp with molybdenum foils, gas-tightly embedded in at least one end section of the lamp, at which at two opposite narrow ends in each case an outer current supply conductor and an electrode or an outer current supply conductor and an inner current supply conductor are arranged, a coating is applied by means of vacuum-arc ion implantation to the molybdenum foils, current supply conductors and/or electrodes, at least in sections, the coating being formed in such a way that the adhesion properties to the glass are improved in the area of the coating.

In this method, the coating is preferably applied to the current-conducting system using an electrical bias. The electrical bias is preferably more than 1000 V. The bias voltage applied to the substrate means that the kinetic energy of the ions in the plasma can be further increased, so that the ions of the coating material penetrate more deeply into the substrate and thus further improve the adhesion of the coating.

According to an exemplary embodiment of the invention, the coating material is implanted at least partially in the surface of the current-conducting system, so that the coated surface consists of a mixture of the basic material and the coating material. The resulting surface is very rough and thus improves the enmeshing effect and sealing effect between the metal of the current supply system and the lamp glass, so that the sealing of the molybdenum foils in the pinched seal is further improved.

It has been shown to be especially advantageous if the coating essentially has a coating thickness of approximately 10 to 100 nm, preferably 50 nm. Because of this relatively thin coating thickness, the adhesion and sealing of the molybdenum foils in the glass of the lamp vessel is improved and the service life of the lamp thus substantially increased.

In an exemplary embodiment of the invention, the coating contains ruthenium, a ruthenium alloy or a ruthenium-molybdenum eutectic.

According to a further preferred exemplary embodiment, the coating contains at least one oxide from the zirconium oxide, yttrium oxide, titanium oxide group or a corresponding mixed oxide.

In a preferred exemplary embodiment of the invention, the coating covers more than 60% of the surface of the current supply system. With this variant, isolated areas of the surface of the current supply system can be left bare, for example to improve the weldability. Furthermore, the arc end of the electrode tips can, at least in sections, be kept free of the coating material by using a mask or the coating in this area can be subsequently removed, for example using a laser or by chemical means.

Preferably, the coating is essentially applied over the complete area of the surface of the current-conducting system. This further improves the high-sealing adhesion of the molybdenum foil to the glass in the lamp glass.

In a preferred embodiment of the invention, the coating is applied at different coating thicknesses to the current-conducting system. For example, the molybdenum foils on one side in the area of the welds can have a thinner coating, to improve the weldability. A coating thickness of approximately 20 nm has proven to be particularly advantageous in this case.

The lamp according to the invention, for example a high-pressure discharge lamp, has at least one current-conducting system where the molybdenum foils, current supply conductors and/or electrodes have a coating, at least in sections, that is formed in such a way that the adhesion properties to the glass are improved in the area of the coating, with the coating being applied to the current-conducting system by vacuum-arc ion implantation (Arc-PVD).

### BRIEF DESCRIPTION OF THE DRAWING

The invention is explained in more detail in the following with the aid of a preferred exemplary embodiment. The single FIGURE shows a schematic representation of a high-pressure discharge lamp with a current-conducting system according to the invention.

### BEST MODE FOR CARRYING OUT THE INVENTION

The FIGURE shows a schematic representation of a high-pressure discharge lamp 1 with a current-conducting system 2 according to the invention. The high-pressure discharge lamp 1 has a discharge vessel 4 of silica glass with an internal space 6 and two diametrically arranged, sealed end sections 8, 10 in each of which a foil 12 of doped molybdenum is embedded to provide gas-tight current conduction. The molybdenum foils 12 are connected at a first narrow end 14 to an outer current supply conductor 16 of doped molybdenum. Two diametrically arranged electrodes 18, 20 of doped tungsten, each of which are connected to a second narrow end 22 of the molybdenum foils 12 and between which a gas discharge forms during the operation of the lamp, project into the internal space 6 of the discharge vessel 4. The internal space 6 of the discharge vessel 4 has an ionizable filling, consisting of high-purity xenon gas and several metal halides, and perhaps mercury. The discharge vessel 4 is surrounded by an outer bulb 24 consisting of silica glass provided with ultraviolet-absorbing dopants. The high-pressure discharge lamp 1 also has a lamp base 26 that carries the discharge vessel 4 and the outer bulb 24. The lamp base 26 has a base housing 28, cylinder-shaped in sections and consisting of electrically insulating plastic, that at the lamp end has a mounting section 30 to mount the lamp 1 in the base housing 28. The mounting section 30 has an annular flange 32, at least in sections, to secure the high-pressure discharge lamp 1 in a lamp holder (not illustrated). The outer current supply conductor 16 of the discharge vessel 4 end section 8 furthest away from the base is connected by a current return conductor 36, surrounded by an insulating sleeve 34, to an electrical terminal ring 38 of the base 26, whereas the outer current supply conductor 16 nearest to the base is connected to an inner contact pin (not illustrated) of the high-pressure discharge lamp 1.

The molybdenum foils 12 used each have an approximately rectangular base shape the rim of which is formed by the opposing narrow ends 14, 22 and two side edges 40, 42 running vertical to the narrow ends 14, 22. The surface 44 of the molybdenum foils 12 is preferably convexly curved with its thickness constantly decreasing from its longitudinal axis to both side edges 40, 42, so that the molybdenum foils 12 form an approximately lanceolate cross section and thus enable a homogeneous voltage pattern in the end sections 8, 10 of the high-pressure discharge lamp 1. According to the invention, a coating 46, that consists of ruthenium with a coating thickness of approximately 50 nm and that improves the adhesion properties to the glass, is applied to the molybdenum foils 12. Because of this relatively thin coating thickness, the adhesion and sealing effect of the molybdenum foils 12 in the end sections 8, 10 of the discharge vessel 4 is improved and the service life of the lamp 1 therefore significantly increased. In a variant (not illustrated) of the invention, the coating 46 contains a ruthenium alloy, a ruthenium-molybdenum eutectic or at least an oxide from the zirconium oxide, yttrium oxide, titanium oxide group or a corresponding mixed oxide.

According to the invention, the coating 46 is applied to the molybdenum foils 12 using vacuum-arc ion implantation (Arc-PVD). The basic principle of vacuum-arc ion implantation is the generation of a short ignition plasma close to a cathode in a vacuum chamber (recipient) and the succeeding release of a heavy-current arc discharge (vacuum arc) between an anode connected to the substrate to be coated, i.e. the molybdenum foils 12, and a cathode (target) from which the coating material is to be taken. The generation of the ignition plasma takes place, for example, by means of a high-voltage electrical impulse on the surface of the cathode that vaporizes and ionizes a small part of the cathode material. The high-grade ionized plasma (ionization grade>95%) required to maintain the vacuum arc is produced by the arc discharge and resulting vaporized cathode material. The vacuum arc causes vaporization of the cathode material, with a large part of the vaporized material being accelerated through an axial magnetic field between the electrodes in the direction of the substrate and implanted in same or deposited on the substrate surface 44. In other words, the ions of the coating material due to their high kinetic energy penetrate the uppermost atom layers of the molybdenum foils 12 and thus form a coating 46 that is closely enmeshed with these and has a high adhesion strength. For this purpose, it is advantageous if the vacuum coating process runs continuously, i.e. no intermediate ventilation of the vacuum chamber takes place and therefore no impurities of the coating, such as, for example, occur due to the sandblasting medium when coating using the sandblasting process, that could lead to a leak in the contact points of the lamp glass and molybdenum foils 12 and thus to premature failure of the lamp 1. Furthermore, the high quality of the adhesion of the coating 46 to the molybdenum foils 12 means that an expensive heat-treatment process is not necessary.

In the exemplary embodiment of the invention shown, the coating 46 is applied to the molybdenum foils 12 using an electrical bias of approximately 1000 V. Due to the applied bias voltage, the kinetic energy of the ions in the plasma can be further increased so that the ions of the coating material penetrate more deeply into the surface 44 of the molybdenum foils 12 and the adhesion of the coating 46 is further improved.

In the exemplary embodiment shown, the coating 46 is applied over the complete area of the surface 44 of the molybdenum foils 12 and partly implanted in same. In this way, a mixture of coating material and base material is achieved in the zones of the molybdenum foils 12 close to the surface. The resulting surface 44 is very rough and can thus increase the enmeshing effect between the metal of the molybdenum foils 12 and the lamp glass and enable a highly sealed embedment of the molybdenum foils 12 in the end sections 8, 10 of the high-pressure discharge lamp 1.

In a variant (not illustrated), isolated areas of the molybdenum foils 12 can be left clear, for example to improve weldability. Furthermore, the coating 46 can be applied at different coating thicknesses to the molybdenum foils 12. For example, the molybdenum foils 12 can be coated on one side with a thinner coating in the area of welds. A coating thickness of approximately 20 nm has proved especially advantageous for this purpose.

The current-conducting system 2 according to the invention is not limited to the high-pressure discharge lamp 1 described, but on the contrary the current-conducting system 2 can be used for various lamp types known from the prior art. It is essential for the invention that the molybdenum foils 12, current supply conductors 16 and/or electrodes 18, 20 are provided with a coating 46, at least in sections, that is formed in such a way that the adhesion properties to the glass are improved in the area of the coating, with the coating 46 being applied to the current-conducting system 2 by means of vacuum-arc ion implantation.

Disclosed is a current-conducting system 2 for a lamp 1 with molybdenum foils, gas-tightly embedded in at least one end section 8, 10 of the lamp 1, at which at two opposite narrow ends 14, 22 in each case an outer current supply conductor 16 and an electrode 18, 20 or an outer current supply conductor 16 and an inner current supply conductor are arranged. According to the invention, the molybdenum foils 12, current supply conductors 16 and/or electrodes 18, 20 are provided with a coating 46, at least in sections, that is formed in such a way that the adhesion properties to the glass are improved in the area of the coating, with the coating 46 being applied to the current-conducting system 2 by means of vacuum-arc ion implantation (Arc-PVD).

1. A current-conducting system for a lamp with molybdenum foils, gas-tightly embedded in at least one end section of the lamp, at which at two opposite narrow ends in each case an outer current supply conductor and an electrode or an outer current supply conductor and an inner current supply conductor are arranged, wherein said molybdenum foils, current supply conductors and/or electrodes are provided with a coating, at least in sections, that is formed in such a way that the adhesion properties to the glass are improved in the area of the coating, with the coating being applied to the current-conducting system by means of vacuum-arc ion implantation.

2. The current-conducting system as claimed in claim 1, with the coating essentially having a coating thickness of approximately 10 to 100 nm, preferably of 50 nm.

3. The current-conducting system as claimed in claim 1, with the coating containing ruthenium, a ruthenium alloy or a ruthenium-molybdenum eutectic.

4. The current-conducting system as claimed in claim 1, with the coating having at least one oxide from the zirconium oxide, yttrium oxide, titanium oxide group or a mixed oxide.

5. The current-conducting system as claimed in claim 1, with the coating covering more than 60% of the surface of the current supply-conducting system.

6. The current-conducting system as claimed in claim 5, with the coating being essentially applied over the complete area of the surface of the current-conducting system.

7. The current-conducting system as claimed in claim 1, with the coating being applied at different coating thicknesses to the current-conducting system.

8. The current-conducting system as claimed in claim 1, with the coating material being implanted at least partially in the surface of the current-conducting system.

9. A method for manufacturing a current-conducting system for a lamp with molybdenum foils, gas-tightly embedded in at least one end section of the lamp, at which at two opposite narrow ends in each case an outer current supply conductor and an electrode or an outer current supply conductor and an inner current supply conductor are arranged, with a coating being applied by means of vacuum-arc ion implantation to the molybdenum foils, current supply conductors and/or electrodes, at least in sections, the coating being formed in such a way that the adhesion properties to the glass are improved in the area of the coating.

10. The method as claimed in claim 9, with the coating being applied to the current-conducting system using an electrical bias.

11. The method as claimed in claim 10, with the electrical bias being more than 1000 V.

12. A lamp, especially a high-pressure discharge lamp with at least one current-conducting system as claimed in claim 1.
